(19) United States
(12) Patent Application Publication
(10) Pub. No.: US 2023/0230473 A1
(43) Pub. Date: Jul. 20, 2023

(54) METHOD OF PROVIDING EARLY WARNING TO DRIVERS APPROACHING A ROAD SECTION WITH ABNORMAL DRIVING CONDITIONS, TRAFFIC EARLY WARNING APPARATUS, AND COMPUTER READABLE STORAGE MEDIUM APPLYING THE METHOD

(71) Applicant: Mobile Drive Netherlands B.V., Amsterdam (NL)

(72) Inventor: JING-LONG YANG, New Taipei (TW)

(21) Appl. No.: 18/088,203

(22) Filed: Dec. 23, 2022

(30) Foreign Application Priority Data
Dec. 31, 2021 (CN) 202111673583.0

(51) Int. Cl. G08G 1/01

(52) U.S. Cl. CPC G08G 1/0141; G08G 1/0112

(57) ABSTRACT

A method of giving early warning of a road section with abnormal driving conditions acquires own-driving information of multiple vehicles in a target region. The own-driving information is used for determining whether an abnormal road section is present. When the abnormal road section is present, a reason for the abnormal road section is confirmed based on images of the abnormal road section. The abnormal road section is determined and early warning given to all vehicles approaching the abnormal road section. A traffic early warning device and a computer readable storage medium applying the method are also disclosed.

### FIELD

The subject matter herein generally relates to traffic safety.

### BACKGROUND

Cars are ever more widespread and traffic safety becomes more important. When a road is in an abnormal condition, such as partial collapse of the roadway or an accident on the road, the abnormal road section needs to be marked at the scene, and a warning notice should be set at the beginning of the road section as a warning to approaching drivers. If the warning notice is not set quickly, congestions and even a crash may occur.

Road safety requires an improvement.

### BRIEF DESCRIPTION OF THE DRAWINGS

Implementations of the present disclosure will now be described, by way of example only, with reference to the attached figures.

FIG. 1 is a diagram illustrating an embodiment of a traffic early warning device according to the present disclosure.

FIG. 2 is a flowchart illustrating an embodiment of a method of providing an early warning to drivers approaching a road section with abnormal driving conditions according to the present disclosure.

FIG. 3 is a diagram illustrating an embodiment of a traffic early warning apparatus according to the present disclosure.

### DETAILED DESCRIPTION

The present disclosure is described with reference to accompanying drawings and the embodiments. It will be understood that the specific embodiments described herein are merely part of all embodiments, not all the embodiments. Based on the embodiments of the present disclosure, it is understandable to a person skilled in the art, any other embodiments obtained by persons skilled in the art without creative effort shall all fall into the scope of the present disclosure. It will be understood that the specific embodiments described herein are merely some embodiments and not all.

It will be understood that, even though the flowchart shows a specific order, an order different from the specific order shown in the flowchart can be implemented. The method of the present disclosure can include one or more steps or actions for achieving the method. The steps or the actions in the method can be interchanged with one another without departing from the scope of the claims herein.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM, magnetic, or optical drives. It will be appreciated that modules may comprise connected logic units, such as gates and flip-flops, and may comprise programmable units, such as programmable gate arrays or processors, such as a CPU. The modules described herein may be implemented as either software and/or hardware modules and may be stored in any type of computer-readable medium or other computer storage systems. The term “comprising” means “including, but not necessarily limited to”; it specifically indicates openended inclusion or membership in a so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

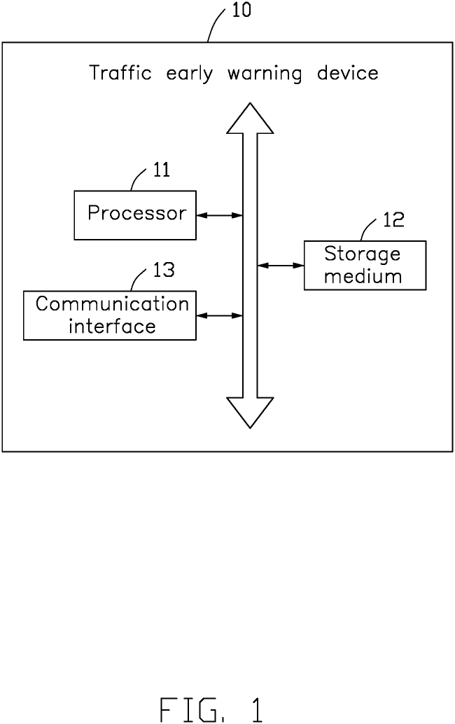

FIG. 1 shows a traffic early warning device 10. The traffic early warning device 10 includes a processor 11, a storage medium 12, and a communication interface 13, which are connected with each other through a bus or directly connected.

The processor 11 is configured to operate computer programs stored in the storage medium 12 to implement a method of the present disclosure (as below). The processor 11 can be a central processing unit (CPU), a microprocessors, digital signal processor (DSP), an application specific integrated circuit (ASIC), a field-programmable gate array (FPGA) or other programmable logic, a discrete gate or transistor logic, discrete hardware components, not being limited thereto.

The storage medium 12 can be a volatile or non-volatile memory, such as a digital versatile disk (DVD) or other optical disk, a magnetic disk, a hard disk, a smart media card (SMC), a secure digital (SD) card, a flash card, not being limited thereto.

The communication interface 13 can establish a communication between a server and multiple vehicle terminals. The server can be an independent physical server, or can be a server cluster or a distributed system including a plurality of physical servers, or may be a cloud server that provides a cloud computing service. The vehicle terminals can be a vehicle-mounted terminal, or can be a mobile terminal carried by a driver. The vehicle terminal can include a mobile phone, a tablet, a notebook, an intelligent speaker, a smart watch, a vehicle server, a vehicle sensor, not being limited thereto. The server communicates with the vehicle terminal through a wireless network for transmitting data. The wireless communication network can include a wireless local area networks (WLANs), a cellular communication network (such as 2G/3G/4G/5G), a satellite communication network, not being limited thereto.

In one embodiment, the traffic early warning device 10 can be a server. The traffic early warning device 10 communicates with vehicle terminals through the communication interface 13.

In another embodiment, the traffic early warning device 10 can be a vehicle-mounted terminal. The traffic early warning device 10 communicates with the server through the communication interface 13. In other embodiments, the traffic early warning device 10 can also communicate with the other vehicles through the communication interface 13.

Other examples of the traffic early warning device 10 can also include more or less components,

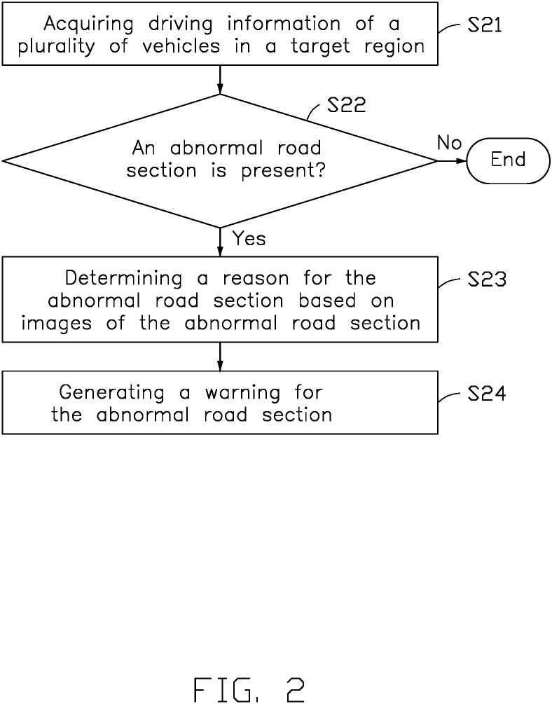

FIG. 2 shows a flowchart of a method of providing early warning to drivers approaching a road section with abnormal driving conditions. As shown in FIG. 2, the method is used in the traffic early warning device 10 (as shown in FIG. 1). As shown in FIG. 2, the method includes the following steps. These steps may be re-ordered.

In block S21, driving information of a plurality of vehicles in a target region is acquired.

In one embodiment, the traffic early warning device 10 is a server. The traffic early warning device 10 can send an instruction to the vehicles in the target region through the communication interface 13 for acquiring the driving information. The vehicle receiving the instruction sends own-driving information to the traffic early warning device 10 through the vehicle terminal. In other embodiments, the vehicles in the target region also can actively send the own-driving information to the traffic early warning device 10. The target region is a region of road from a starting position to an ending position on a predefined driving route.

In one embodiment, the driving information can include location information and sensor information. The location information is information of the vehicle as to physical location. In one embodiment, the vehicle terminal can acquire the location information by a location system, and send the location information to the traffic early warning device 10. The location system can include a global positioning system (GPS), a BEIDOU navigation satellite system (BDS), a Galileo satellite navigation system (GALILEO), a global navigation satellite system (GLONASS), not being limited thereto.

The sensor information can be information sensed by sensors of each vehicle. The sensor can be a camera sensor, a laser radar, a millimeter-wave radar, an ultrasonic radar, an infrared radar, an acceleration sensor, a sensor of an electronic stability controller (ESC), a sensor of a tracking anti-skid control system, not being limited thereto. The sensor can sense various parameters, such as light, heat, pressure, for monitoring the state of the vehicle. The sensor can be mounted on a front bumper, a rear bumper, a side-view mirror, inside a joystick, or on a windscreen of the vehicle.

In other embodiments, the own-driving information also can include at least one of map information and driving behavior information. The map information can be information of map and traffic shown in images, animated images, or as a video. In one embodiment, the traffic early warning device 10 can acquire the map information through application programs. The application programs can provide a map function, such as a BAIDU map or a GAODE map, not being limited thereto.

The driving behavior information can be information as to vehicle operation. The driving behavior information can include starting of an anti-lock braking system (ABS), starting an electric power steering (EPS), an emergency brake, a rotation angle of a steering wheel, not being limited thereto.

The driving information also can include other information representing the state of the vehicle.

In another embodiment, the traffic early warning device 10 is a vehicle-mounted terminal, the traffic early warning device 10 sends a request to the other vehicles in the target region for acquiring the own-driving information of the other vehicles through the communication interface 13. After receiving the request, the other vehicles can send the such information to the traffic early warning device 10.

In another embodiment, the traffic early warning device 10 is a vehicle terminal, the traffic early warning device 10 sends a request to the server for acquiring the own-driving information of the other vehicles in the target region through the communication interface 13. After receiving the request, the server sends the instruction to the other vehicles in the target region for acquiring the own-driving information of the other vehicles. After receiving the instructions, the other vehicles send their own-driving information to the server. The server sends the received own-driving information of the other vehicles to the traffic early warning device 10. In other embodiments, the server also can broadcast the received own-driving information to all the vehicles in the target region.

In block S22, whether an abnormal road section is present in the target region according to the driving information of the plurality of vehicles is determined. If the abnormal road section in the target region is present, the procedure goes to block S23. If there is no abnormal road section in the target region, the procedure ends.

In one embodiment, the traffic early warning device 10 monitors the state of the vehicle based on the sensor information, and determines whether the vehicle is being operated in an abnormal manner for determining whether the abnormal road section is present in the target region. The abnormal manner can include an abnormal swerving, an abnormal stopping, or an abnormal driving speed, not being limited thereto.

In one embodiment, the traffic early warning device 10 monitors the position of the vehicle in time based on the location information. When the abnormal road section is deemed to exist, the position of the abnormal road section is confirmed. By reference to the location information, the traffic early warning device 10 deems the location of the road section, where no vehicle is passing through, as an abnormal road section.

In other embodiment, the traffic early warning device 10 also can acquire physical and traffic information in the target region based on the map information. For example, the traffic early warning device 10 determines whether a closed road section or a congested road section in the target region based on the map information. When a closed road section or a congested road section in the target region, the traffic early warning device 10 can re-plan a driving route for avoiding the closed road section and the congested road section.

The traffic early warning device 10 also can determine whether a driver performs an abnormal operation to a vehicle, based on the driver behavior information in determining whether an abnormal road section is present in the target region. The abnormal driving behavior can include an abnormal turning, a high frequency braking, or an emergency brake, not being limited thereto. The turning operation can be sensed by the rotation angle of the steering wheel. The abnormal turning of the abnormal operation is determined to exist when the road section where it occurs is a straight road section or when turning is forbidden.

The traffic early warning device 10 also can determine whether a driver performs an abnormal operation to a vehicle, based on the driving behavior information and the location information for determining whether the abnormal road section is present.

In block S23, a reason for the abnormal road section is confirmed based on images of the abnormal road section.

The traffic early warning device 10 acquires images of the abnormal road section. In one embodiment, the traffic early warning device 10 can control cameras of the vehicle in communication with it to capture images of the abnormal road section. In other embodiments, the traffic early warning device 10 also can acquire images of the abnormal road section through the communication interface 13 connected with a network traffic management platform. The network traffic management platform can capture image of the abnormal road section through cameras mounted and fixed on the road.

The traffic early warning device 10 can detect the reason for the abnormal road section, based on the image of the abnormal road section. The abnormal reason can be partial or complete collapse, accident, or obstacles which have been dropped on the road, not being limited thereto. In one embodiment, the traffic early warning device 10 extracts image features from the image of the abnormal road section, and compares the image features with abnormality features of abnormality for determining whether the image features are abnormal features. The abnormal features have a relationship with abnormal traffic flow and the reasons of abnormality.

The traffic early warning device 10 can store a table of relationships with the abnormal features, the abnormal traffic flow, and the reasons of abnormalities.

In block S24, a warning for the abnormal road section is generated.

In one embodiment, a warning manner of the traffic early warning device 10 can be a broadcast notice, a pushed message, a voice prompt, a text prompt, not being limited thereto.

In one embodiment, the traffic early warning device 10 can warn the vehicles in the target region when such vehicles are tending to approach the abnormal road section. In other embodiments, the traffic early warning device 10 also can provide a warning message to the network traffic management platform, thus the vehicles in a wider range can receive an early warning from the network traffic management platform. The traffic early warning device 10 also can embed the determined a reason for abnormality in the warning message, and send the warning message to a local traffic management department, advising the traffic management department to detect and repair the abnormal road section in time.

The block S24 can be implemented before the block S23 by the traffic early warning device 10.

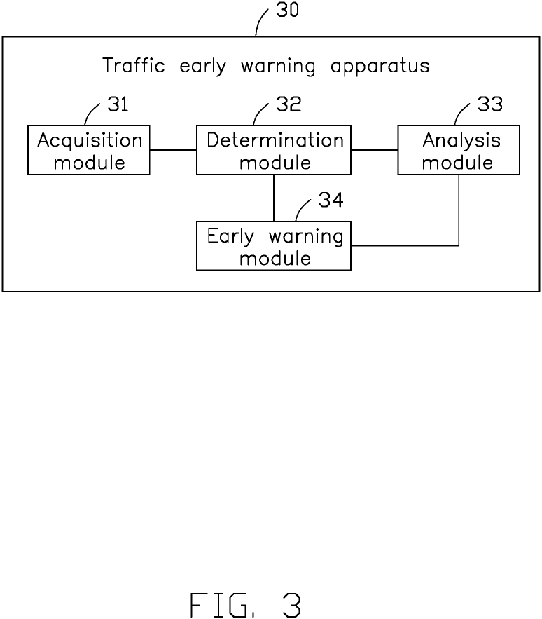

FIG. 3 shows a traffic early warning apparatus 30. The traffic early warning apparatus 30 includes an acquisition module 31, a determination module 32, an analysis module 33, and an early warning module 34. The determination module 32 is electrically connected to the acquisition module 31, the analysis module 33, and the early warning module 34. The analysis module 33 is electrically connected to the early warning module 34.

The acquisition module 31 is configured to acquire driving information of a plurality of the vehicles in the target region.

The determination module 32 is configured to determine whether an abnormal road section is present in the target region.

The analysis module 33 is configured to determine the reason for the abnormal road section, based on images of the abnormal road section.

The early warning module 34 is configured to generate a warning for the abnormal road section.

In one embodiment, the traffic early warning apparatus 30 is a server. The acquisition module 31 can send an instruction to the vehicles in the target region through the communication interface 13 for acquiring the own-driving information. The vehicle receiving the instruction sends the own-driving information to the traffic early warning apparatus 30 through the vehicle terminal, and the acquisition module 31 receives same. In other embodiments, the vehicles in the target region also can actively send own-driving information to the traffic early warning apparatus 30. The target region is a region of road from a starting position to an ending position on a predefined driving route.

In one embodiment, the driving information can include location information and sensor information. In other embodiments, the driving information also can include at least one of map information and driving behavior information.

In another embodiment, the traffic early warning apparatus 30 is a vehicle-mounted terminal, the acquisition module 31 sends a request to other vehicles in the target region for acquiring the own-driving information of the other vehicles. After receiving the request, the other vehicles send own-driving information to the traffic early warning apparatus 30, and the acquisition module 31 receives same.

In another embodiment, the traffic early warning apparatus 30 is a vehicle terminal, the acquisition module 31 sends a request to the server for acquiring the own-driving information of the other vehicles in the target region. After receiving the request, the server sends the instruction to the other vehicles in the target region for acquiring the own-driving information of each of the other vehicles. After receiving the instructions, the other vehicles send the own-driving information to the server. The server sends such information of the other vehicles to the traffic early warning apparatus 30, and the acquisition module 31 receives the driving information. In other embodiments, the server also can broadcast the received own-driving information to all the vehicles in the target region, and the acquisition module 31 receives same.

In one embodiment, the determination module 32 can monitor the state of each vehicle based on the sensor information, and determine whether a driver performs an abnormal operation to a vehicle for determining whether an abnormal road section is present in the target region. The abnormal operation can include an abnormal swerving, an abnormal stopping, or an abnormal driving speed, not being limited thereto.

In one embodiment, the determination module 32 monitors the position of the vehicle in time based on the location information for determining the position of the abnormal road section in quick time.

In one embodiment, the analysis module 33 acquires images of the abnormal road section and determines the reason for the abnormal road section based on the images of the abnormal road section. The reason can be partial or total collapse of the road, accident, and dropped obstacles, not being limited thereto.

In one embodiment, the analysis module 33 can control cameras of the vehicle to capture images of the abnormal road section. In other embodiments, the analysis module 33 also can acquire the images of the abnormal road section through the communication interface 13 connected with a network traffic management platform. The network traffic management platform can capture images of the abnormal road section through cameras mounted and fixed on the road.

In one embodiment, the analysis module 33 extracts image features from the images of the abnormal road section, and compares the image features to abnormality features for determining whether the image features are abnormal features. The abnormal features have a relationship with abnormal traffic flow and the reasons for the abnormal road section. The analysis module 33 confirms the abnormal traffic flow and the reason for the abnormal road section based on the abnormality features.

In one embodiment, a warning of the early warning module 34 can be a broadcast notice, a pushed message, a voice prompt, a text prompt, not being limited thereto.

In one embodiment, the early warning module 34 can warn all the vehicles in the target region tending to approach the abnormal road section. In other embodiments, the early warning module 34 also can provide a warning message to the network traffic management platform, thus the vehicles in a wider range can receive early warning from the network traffic management platform. The early warning module 34 also can embed the abnormal reason in the warning message, and send the warning message to a traffic management department, assisting the traffic management to detect and repair the abnormal road section in quick time.

In one embodiment, the acquisition module 31, the determination module 32, the analysis module 33, and the early warning module 34 can be computer programs with specified functions. The computer programs can be stored in the storage medium 12, and can be operated by the processor 11 of the traffic early warning device 10 for implementing the method of providing early warning to drivers approaching a road section with abnormal driving conditions.

The present disclosure also provides a computer readable storage medium disposed in the server for storing computer programs. The computer programs are operated by the processor for implementing the method of providing early warning to drivers approaching a road section with abnormal driving conditions.

The computer readable storage medium can be a volatile, a non-volatile, a removable, or an unremovable memory for storing information (such as computer readable instruction, data structure, program modules or other data) in each method or technology. The computer-readable storage medium can be a random-access memory (RAM), a read-only memory (ROM), an electrically erasable programmable read-only memory (EEPROM), a flash memory or other medium technology, a compact disc ROM (CD-ROM), a digital video disk (DVD) or other optical disk, a magnetic cassette, a magnetic tape, a magnetic disk or other magnetic storage medium, or other medium for storing expected information and being accessed by a processor, not being limited thereto.

In some embodiments, all or part of the steps of the method, and functional modules in the traffic early warning apparatus 30 disclosed above can be implemented as software, firmware, hardware and appropriate combinations thereof.

In a hardware embodiment, the division of functional modules mentioned in the above description does not correspond to separate physical components. For example, one physical component may have multiple functions, or one function or step may be executed jointly by one or more physical components. Some or all components are implemented as software executed by processors such as central processing units, digital signal processors or microcontrollers, hardware, or integrated circuits such as application specific integrated circuits.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing an early warning of road conditions, the method being applicable in a traffic early warning device, the traffic early warning device comprises a storage medium with computer programs and a processor; the processor executes the computer programs to implement the following:
acquiring driving information of a plurality of vehicles in a target region;
determining, according to the driving information of the plurality of vehicles, whether an abnormal road section is present in the target region;
determining a reason for the abnormal road section based on an image of the abnormal road section, when an abnormal road section is present in the target region; and
generating a warning for the abnormal road section.

2. The method of claim 1, wherein the driving information comprises location information, sensor information, and at least one of map information and driving behavior information.

3. The method of claim 2, wherein the step of determining whether an abnormal road section is present in the target region comprises:
determining whether one of the plurality of vehicles is driving in an abnormal manner based on the sensor information; and
determining that an abnormal road section is present in the target region, when one of the plurality of vehicles is driving in the abnormal manner.

4. The method of claim 3, further comprising:
locating a position of the abnormal road section based to the location information, after determining that an abnormal road section is present in the target region.

5. The method of claim 2, wherein the step of determining whether an abnormal road section is present in the target region comprises:
determining whether a closed road section or a congested road section is present in the target region, based on the map information.

6. The method of claim 2, wherein the step of determining whether an abnormal road section is present in the target region comprises:
determining whether a driver performs an abnormal operation to a vehicle, based on the driving behavior information; and
determining that an abnormal road section is present in the target region, when the driver performs an abnormal operation to the vehicle.

7. The method of claim 1, wherein the step of determining a reason for the abnormal road section based on an image of the abnormal comprises:
extracting image features from the image of the abnormal road section;
comparing the image features to preset abnormal features, for determining whether the image features are abnormal features; and
determining the reason for the abnormal road section based on comparing the image features to preset abnormal features.

8. A traffic early warning device comprises:
a storage medium; and
a processor,
wherein the storage medium stores computer programs, and
the processor executes the computer programs to implement the following:
acquiring driving information of a plurality of vehicles in a target region;
determining whether an abnormal road section is present in the target region;
determining a reason for the abnormal road section based on an image of the abnormal road section when the abnormal road section is present in the target region; and
generating a warning of the abnormal road section.

9. The traffic early warning device of claim 8, wherein the driving information comprises location information, sensor information, and at least one of map information and driving behavior information.

10. The traffic early warning device of claim 9, wherein the processor further implements:
determining whether one of the plurality of vehicles is driving in an abnormal manner based on the sensor information; and
determining that an abnormal road section is present in the target region when one of the plurality of vehicles is driving in the abnormal manner.

11. The traffic early warning device of claim 10, wherein the processor further implements:
locating a position of the abnormal road section based to the location information, after determining that an abnormal road section is present in the target region.

12. The traffic early warning device of claim 8, wherein the processor further implements:
determining whether a closed road section or a congested road section is present in the target region, based on the map information.

13. The traffic early warning device of claim 9, wherein the processor further implements:
determining whether a driver performs an abnormal operation to a vehicle, based on the driving behavior information; and
determining that an abnormal road section is present in the target region, when the driver performs an abnormal operation to the vehicle.

14. The traffic early warning device of claim 8, wherein the processor further implements: extracting image features from the image of the abnormal road section;
comparing the image features to preset abnormal features, for determining whether the image features are abnormal features; and
determining the reason for the abnormal road section based on comparing the image features to the present abnormal features.

15. A computer readable storage medium, the computer readable storage medium stores computer programs, and the computer programs are executed by at least one processor to implement the following steps:
acquiring driving information of a plurality of vehicles in a target region;
determining, according to the driving information of the plurality of vehicles, whether an abnormal road section is present in the target region;
determining a reason for the abnormal road section based on an image of the abnormal road section if it is determined that the abnormal road section is present in the target region; and
generating a warning for the abnormal road section.

16. The computer readable storage medium of claim 15, wherein the driving information comprises location information, sensor information, and at least one of map information and driving behavior information.

17. The computer readable storage medium of claim 16, wherein the step of determining whether an abnormal road section is present in the target region comprises:
determining whether one of the plurality of vehicles is driving in an abnormal manner based on the sensor information;
determining that an abnormal road section is present when one of the plurality of vehicles is driving in the abnormal manner; and
locating a position of the abnormal road section based to the location information, after determining that an abnormal road section is present in the target region.

18. The computer readable storage medium of claim 16, wherein the step of determining whether an abnormal road section is present in the target region comprises:
locating a position of the abnormal road section.

19. The computer readable storage medium of claim 16, wherein the step of determining whether an abnormal road section is present in the target region comprises:
determining that an abnormal road section is present in the target region, when the driver performs an abnormal operation to the vehicle, based on the driving behavior information; and
determining that that an abnormal road section is present in the target region, when the driver performs an abnormal operation to the vehicle.

20. The computer readable storage medium of claim 15, wherein the step of determining the reason for the abnormal road section based on an image of the at abnormal road section comprises:
extracting image features from the image of the abnormal road section;
comparing the image features to preset abnormal features for determining whether the image features are abnormal features; and
determining the reason for the abnormal road section based on comparing the image features to preset abnormal features.
